(19) United States
(12) Patent Application Publication
(10) Pub. No.: US 2008/0187617 A1
(43) Pub. Date: Aug. 7, 2008

(54) Valve Bushing and Associated Method of Use

(75) Inventors: Daniel Wayne BARNETT, Georgia, VT (US); Edward Joseph JENKO, Essex, VT (US)

Correspondence Address: HUSKY INJECTION MOLDING SYSTEMS, LTD;CO/AMC INTELLECTUAL PROPERTY GRP, 500 QUEEN ST. SOUTH, BOLTON, ON, L7E 5S5, omitted

(73) Assignee: HUSKY INJECTION MOLDING SYSTEMS LTD., Bolton (CA)

(21) Appl. No.: 11/670,459

(22) Filed: Feb. 2, 2007

(51) Int. Cl. B29C 45/23

(52) U.S. Cl. 425/565

(57) ABSTRACT

A valve bushing for an injection molding apparatus and method of use is disclosed. This includes an actuator, a manifold having an internal channel for the flow of melted resin, a valve stem, having a longitudinal axis, and is operatively connected to the actuator and movable within at least a portion of the internal channel of the manifold, and a valve bushing that at least partially encircles the valve stem along the longitudinal axis, wherein the valve bushing includes a projecting member so that when pressure is applied to a bottom portion of the valve bushing, that deflection of the valve bushing occurs along the longitudinal axis of the valve stem, which is then translated into radial constriction by the projecting member of the valve bushing to reduce leakage.

### BACKGROUND OF INVENTION

Valve bushings utilized in injection molding equipment require a precise fit between the stem and the bushing to ensure that excessive leakage of resin does not occur. Resins that have a melt flow index (“MFI”) of greater than 80 can excessively leak even with a small gap. Leakage is becoming an increasing challenge as new low viscosity resins continue to emerge. However, a tight fit between the stem and the bushing can cause the stem to seize. Also, the manufacturing tolerances that are required to prevent leaks are very exacting and costly.

An approach that has been utilized to address this situation is the use of coatings and/or treatments of not only the valve stem but the valve bushing to prevent resin leakage. This provides for a very expensive approach for dealing with this problem.

Another approach to this situation is disclosed in U.S. Pat. No. 6,840,758 (Babin et al.). This patent discloses a spacer that is compressed between an actuator block and a manifold block. The compression causes the spacer to radially compress to cause the bushing to prevent seepage from traveling up the valve stem and the bushing. However, if too much pressure is applied to the spacer, then valve stem seizure will occur. Also, too little compression may provide leakage.

Still another approach is disclosed in U.S. Pat. No. 6,159,000 (Puri et al.), which discloses a guide sleeve that has a narrow portion that clings to the outside of the valve stem. However, this guide sleeve does not assert any additional pressure to block the flow of resin, especially low viscous resin having a high MFI.

U.S. Pat. No. 6,729,871 (Sattler et al.) discloses the utilization of a cooled bush that increases the viscosity of the melted thermoplastic material in the gap between the stem and the bush. In this manner, leakage is prevented even when the gap is large; however, additional energy and resources are required to provide the cooling, and in this manner there are also issues created involving maintenance. A similar approach is to require cooling to a back plate to increase resin viscosity and prevent resulting leakage. This again is a very costly approach with regard to not only initial expenditures but also energy costs as well as ongoing maintenance.

U.S. Pat. No. 5,518,393 (Gessner) discloses a bushing having a melt channel for mating with a melt channel in a manifold in which the bushing is housed and with an axial channel in a nozzle body. The bushing is sized to fit within a bore in the manifold in an attempt to reduce the possibility of leakage between the bushing and the manifold. However, there is nothing in this structure that will provide additional constriction on the valve stem to reduce resin leakage in the presence of heat, pressure and a high MFI resin.

U.S. Pat. No. 4,344,750 (Gellert) discloses an electrically heated sprue bushing seated in a well in the cavity plate with a centrally extending melt runner passage which branches radially outward with separate channels leading to a number of edge gates in the cavity plate. An air gap is provided to insulate the hot sprue bushing from the surrounding cooled cavity plate and a hollow seal is provided at each gate to convey the melt across the air gap. This heating of the metal applies the pressure to reduce resin flow. This is a feature that requires significant energy consumption as well as more maintenance due to increased complexity.

U.S. Pat. No. 5,885,628 (Swenson et al.) discloses an injection molding nozzle for disposition in a mold. The nozzle is for injecting melt into a cavity of the mold, and includes a body having a through bore extending therethrough for receiving the melt. A nozzle member surrounds the body at a position upstream of the nozzle piece and has an inner surface contacting the body and an outer surface contacting the mold that forms a seal against melt flow upstream from the nozzle member. Swenson et al. does not apply any additional pressure to the valve stem to prevent resin flow when resin is flowing in the nozzle.

U.S. Pat. No. 6,555,044 (Jenko) discloses a bushing held in the manifold by a nut that traps a back-up pad. When this nut is tightened, a metal “O” ring seals tightly to reduce plastic leakage along the bore of the bushing. However, “O” rings eventually wear out and with vibration; the nut can loosen up to allow resin flow.

The present invention is directed to overcoming one or more of the problems set forth above.

### SUMMARY OF INVENTION

In an aspect of this invention, an injection molding apparatus is disclosed. This injection molding apparatus includes an actuator, a manifold having an internal channel for the flow of melted resin, a valve stem, having a longitudinal axis, and is operatively connected to the actuator and movable within at least a portion of the internal channel of the manifold, and a valve bushing that at least partially encircles the valve stem along the longitudinal axis, wherein the valve bushing includes a projecting member so that when pressure is applied to a bottom portion of the valve bushing, that deflection of the valve bushing occurs along the longitudinal axis of the valve stem, which is then translated into radial constriction by the projecting member of the valve bushing to reduce leakage.

In another aspect of this invention, an injection molding apparatus is disclosed. This injection molding apparatus includes an actuator, a manifold having an internal channel for the flow of melted resin, a valve stem, having a longitudinal axis, and is operatively connected to the actuator and movable within at least a portion of the internal channel of the manifold, and a valve bushing that at least partially encircles the valve stem along the longitudinal axis, wherein the valve bushing includes a projecting member, and an upper member that is positioned adjacent to the projecting member so that when pressure is applied to a bottom portion of the valve bushing, that deflection of the valve bushing occurs along the longitudinal axis of the valve stem, which is then translated into radial constriction, by the projecting member of the valve bushing being wedged against a contacting surface of the upper member, to reduce leakage.

In yet another aspect of this invention, an injection molding apparatus is disclosed. This injection molding apparatus includes an actuator, a manifold having an internal channel for the flow of melted resin, a valve stem, having a longitudinal axis, and is operatively connected to the actuator and movable within at least a portion of the internal channel of the manifold, a valve bushing that at least partially encircles the valve stem along the longitudinal axis, and includes a projecting member, wherein the projecting member includes a top portion having a ferrule, which includes resilient metal, and an upper member that is positioned adjacent to the projecting member so that melted resin, without force against a bottom portion of the valve stem, can apply pressure to the ferrule, which is then translated into radial constriction, by the projecting member of the valve bushing being wedged against a contacting surface of the upper member, to reduce leakage.

In still yet another aspect of this invention, a valve bushing for use in an injection molding apparatus is disclosed, which includes an actuator, a manifold having an internal channel for the flow of melted resin, and a valve stem, having a longitudinal axis, and is operatively connected to the actuator and movable within at least a portion of the internal channel of the manifold. The valve bushing includes a projecting member so that when pressure is applied to a bottom portion of the valve bushing, that deflection of the valve bushing occurs along the longitudinal axis of the valve stem, which is then translated into radial constriction by the projecting member of the valve bushing to reduce leakage, wherein the valve bushing that at least partially encircles the valve stem along the longitudinal axis.

In still another aspect of this invention, an injection molding apparatus is disclosed. This injection molding apparatus includes an actuator, a manifold having an internal channel for the flow of melted resin, and a valve stem, having a longitudinal axis, and is operatively connected to the actuator and movable within at least a portion of the internal channel of the manifold, is disclosed. The valve bushing includes a projecting member so that when pressure is applied to a bottom portion of the valve bushing, that deflection of the valve bushing occurs along the longitudinal axis of the valve stem, which is then translated into radial constriction by the projecting member of the valve bushing to reduce leakage, wherein the valve bushing that at least partially encircles the valve stem along the longitudinal axis.

In another aspect of this invention, a method for utilizing an injection molding apparatus is disclosed. The method includes utilizing a valve bushing that at least partially encircles the valve stem along a longitudinal axis, wherein the valve bushing includes a projecting member so that when pressure is applied to a bottom portion of the valve bushing, that deflection of the valve bushing occurs along the longitudinal axis of the valve stem, which is then translated into radial constriction by the projecting member of the valve bushing to reduce leakage, wherein the valve stem is operatively connected to an actuator and movable within at least a portion of an internal channel of a manifold.

In yet another aspect of this invention, a method for utilizing an injection molding apparatus is disclosed. The method includes utilizing a valve bushing that at least partially encircles the valve stem along a longitudinal axis, wherein the valve bushing includes a projecting member, wherein the projecting member includes a top portion having a ferrule, which includes resilient metal so that melted resin can apply pressure to the ferrule which is then translated into radial constriction by the projecting member of the valve bushing to reduce leakage even if no pressure is applied to a bottom portion of the valve bushing.

These are merely some of the innumerable aspects of the present invention and should not be deemed an all-inclusive listing of the innumerable aspects associated with the present invention. These and other aspects will become apparent to those skilled in the art in light of the following disclosure and accompanying drawings.

### BRIEF DESCRIPTION OF DRAWINGS

For a better understanding of the present invention, reference may be made to the accompanying drawings in which:

FIG. 1 is a sectional view through an injection molding apparatus of the present invention having a valve bushing in accordance with a preferred embodiment of the present invention;

FIG. 2 is an isolated view of valve bushing, as shown in FIG. 1, in accordance with the preferred embodiment of the present invention;

FIG. 3 is a sectional view through an injection molding apparatus of the present invention having a valve bushing in accordance with an alternative embodiment of the present invention;

FIG. 4 is an isolated view of valve bushing, as shown in FIG. 3, in accordance with an alternative embodiment of the present invention;

FIG. 5 is an illustrative schematic that illustrates the function of the valve bushing, in an exaggerated state to creating a wedging effect, without a valve stem to support the inner diameter in accordance with the alternative embodiment of the present invention as shown in FIG. 3;

FIG. 6 is a graphical representation of contact pressure on a valve stem as a function of the distance from the tip of the bushing in accordance with the alternative embodiment of the present invention as shown in FIG. 3; and

FIG. 7 is an illustrative schematic that illustrates a modification of the alternative embodiment of the present invention as shown in FIG. 3 utilizing a ferrule having a resilient metal, e.g., resilient steel, located at the top portion of the valve bushing.

### DETAILED DESCRIPTION OF THE INVENTION

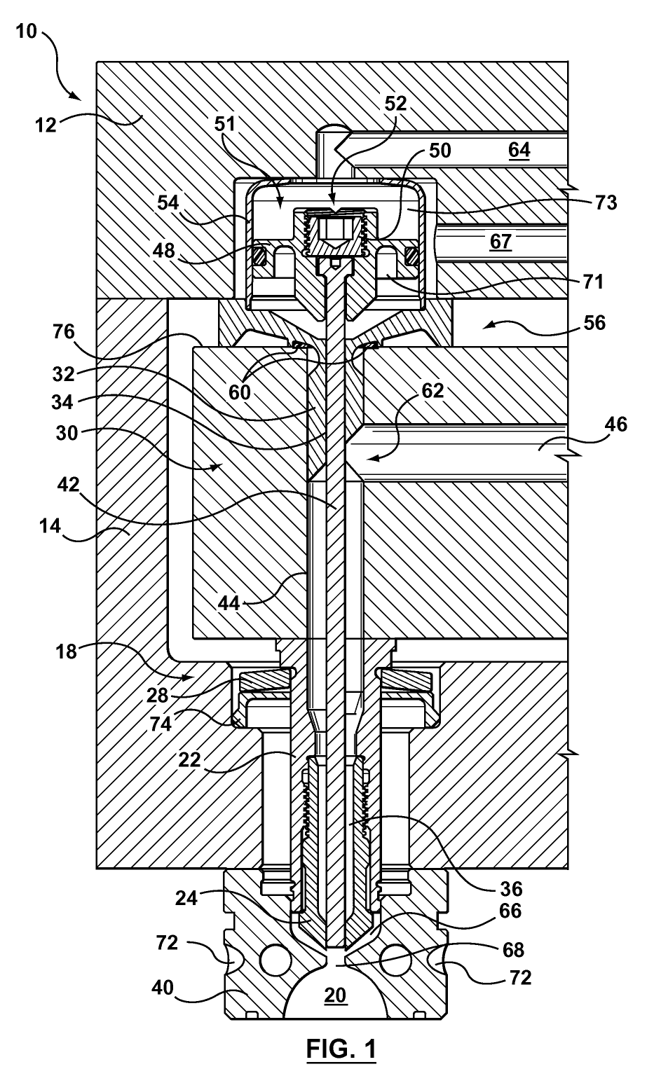

Referring initially to FIG. 1, a hot runner valve gate system for injecting resin into a mold, or the like, is illustrated and is generally indicated by numeral 10. The system includes a backing plate 12 and a manifold plate 14. The system also includes a nozzle assembly 18 for introducing melted resin into a mold cavity 20. The nozzle assembly 18 is located within the manifold plate 14 and includes a nozzle housing 22 with a nozzle tip 24 secured thereto. There is a heater (not shown) that is at least partially positioned on an outside diameter of the nozzle housing 22. The heater may be any suitable heater known in the art to which current is provided by way of an electric cable. There is a wide variety of heat conductive materials that can be utilized for the nozzle housing 22, and an illustrative, but nonlimiting, example includes steel. Also, there is a wide variety of heat conductive materials that can be utilized for the nozzle tip 24, and an illustrative, but nonlimiting, example includes copper alloys.

The nozzle housing 22 includes an axial channel 36 through which melted resin can flow. The nozzle tip 24 surrounds a terminal portion of the axial channel 36. There is a valve stem 42 that controls the opening and closing of the melt channel opening 68 located in the gate insert 40 that controls the flow of melted resin into the mold cavity 20. There is an insulator 66 that occupies the space between the nozzle tip 24 and the gate insert 40 and also contains a melt channel opening 68 located therein. There are cooling channels 72 in the gate insert 40 that allow the melted resin to solidify in the mold cavity 20 prior to the opening of a mold (not shown).

The valve stem 42 can be made of a wide variety of shapes and materials. An illustrative, but nonlimiting, embodiment of a valve stem 42 includes a steel rod. The valve stem 42 extends through a passageway 44 in a manifold 30 and into the nozzle housing 22. The passageway 44 connects to a melt channel 46 located in the manifold 30. The end of the valve stem 42 that is located opposite to the gate insert 40 is connected to a piston head 48 by means of a threaded clamp 50.

There is an actuator that is generally indicated by numeral 51, which includes a piston 52 having a piston head 48 that is housed within a cylinder 54 and the backing plate 12. Fluid, e.g., pneumatic air, is selectively provided through a first channel 64 into an upper chamber 73 to apply downward pressure on the piston 52. The downstroke of the piston 52 causes the valve stem 42 to close and/or reduce the cross-sectional area of the gate insert 40 to restrict or stop the flow of melted resin into the mold cavity 20. Fluid, e.g., pneumatic air, is selectively provided through a second channel 67 into a lower chamber 71 to apply upward pressure on the piston 52. The upstroke of the piston 52 causes the valve stem 42 to open and/or increase the cross-sectional area of the gate insert 40 to allow the flow of melted resin into the mold cavity 20.

The manifold 30 is formed between the manifold plate 14 and the backing plate 12 and is separated from the manifold plate 14 and the backing plate 12 by an air gap 56. The manifold 30 includes the melt channel 46 that forms a portion of the hot runner system that transports melted resin from a source (not shown) to the gate insert 40 associated with a mold cavity 20. The manifold 30 houses a valve bushing 32. There is a wide variety of materials that can be utilized for the manifold 30, which can include any suitable metal or heat conducting material known in the art. The valve bushing 32 is preferably, but not necessarily, formed of flexible metal, e.g., strong steel, which has a predictable flexibility when shaped correctly and which can constrict under pressure. The valve bushing 32, which includes an aperture 34, surrounds a portion of the valve stem 42. There is also a melt channel opening 62 that is in fluid relationship with the melt channel 46 in the manifold 30 and the axial channel 36 in the nozzle assembly 18.

There is a disk spring 28 that will deflect as the cylinder 54, the manifold 20, and the nozzle housing 22 expand due to an increase in temperature. This disk spring 28 will create a resilient spring action in the nozzle assembly 18, which is independent of sealing action created by the valve bushing 32 and the manifold 30 as well as between the valve bushing 32 and the backing plate 12. The disk spring 28 is mounted on a nozzle insulator 74, where the nozzle insulator 74 is adjacent to and supports the nozzle housing 22.

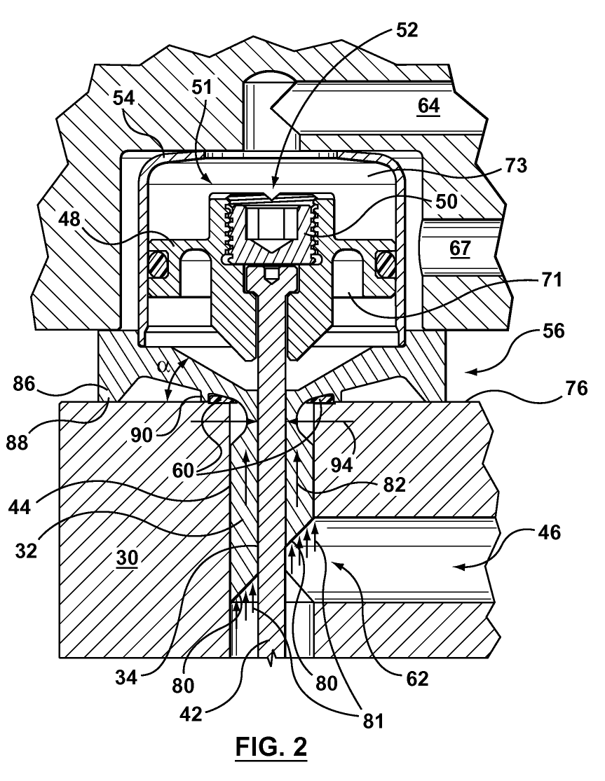

Referring now to FIG. 2 and as previously discussed above, mounted within the manifold 30 is the valve bushing that is indicated by numeral 32. When melted resin enters the melt channel 46 in the manifold 30, the melted resin then passes into a melt channel opening 62 in the passageway 44. The melted resin applies upward pressure against a lower, end portion 80 of the valve bushing 32. This upward injection pressure 81 on the lower, end portion 80 deflects the valve bushing 32 and moves the valve bushing 32 upward axially 82 along the passageway 44. There is a projecting member 86 extending outward from the valve bushing 32 within the air gap 56.

Preferably, the projecting member 86 is traverse to the passageway 44, and preferably in an angle α is in a range from about twenty degrees to about seventy degrees from a line that is perpendicular to the longitudinal axis of the valve stem 42; more preferably, the angle α is in a range from about thirty degrees to about sixty degrees from a line that is perpendicular to the longitudinal axis of the valve stem 42; most preferably, the angle α is in a range from about forty degrees to about fifty degrees from a line that is perpendicular to the longitudinal axis of the valve stem 42 where the optimal value of angle α is forty-five degrees from a line that is perpendicular to the longitudinal axis of the valve stem 42. The projecting member 86 preferably includes at least one leg portion extending downward from the projecting member 86 in preferably a vertical direction to contact a portion, which is the upper surface 76 of the manifold 30 and the lower portion of the air gap 56. In the preferred illustrative, but nonlimiting, embodiment, there is a first leg portion 88 and a second leg portion 90.

Therefore, the valve bushing 32 forms a cantilever structure that is preferably but not necessarily m-shaped, in cross-section, so that when the previously described upward force from injection pressure 81 is applied to the valve bushing 32, axial movement, indicated by arrows 82, is then translated to radial deflection, indicated by force arrows 94, of the valve bushing 32 to constrict and reduce resin flow from melt channel opening 62 between the aperture 34 of the valve bushing 32 and the valve stem 42. The reactive support for the valve bushing 32 is located outside the aperture 34 of the valve bushing 32 and can possibly reduce or eliminate any cooling needed for the backing plate 12, previously shown in FIG. 1. The axial force due to a cantilever-effect causes the aperture 34 within the valve bushing 32 to constrict in a radial direction as shown by the force arrows indicated by numeral 94. It is the application of injection molding pressure 81 against the lower, end portion 80 of the valve bushing 32 that creates the restriction of the stem aperture 34. As an illustrative, but nonlimiting, example, with a nozzle force of 6,000 pound-force, the aperture 34 can constrict by less than 1 micron, but with the same nozzle force of 6,000 pound-force with an injection pressure of 20 kilo-pound per square inch, the aperture 34 can constrict by 6 microns. There is a seal 60 that is located between the valve bushing 32 and an upper surface 76 for the manifold 30. This operates to prevent plastic leakage between the manifold 30 and the valve bushing 32 through passageway 44.

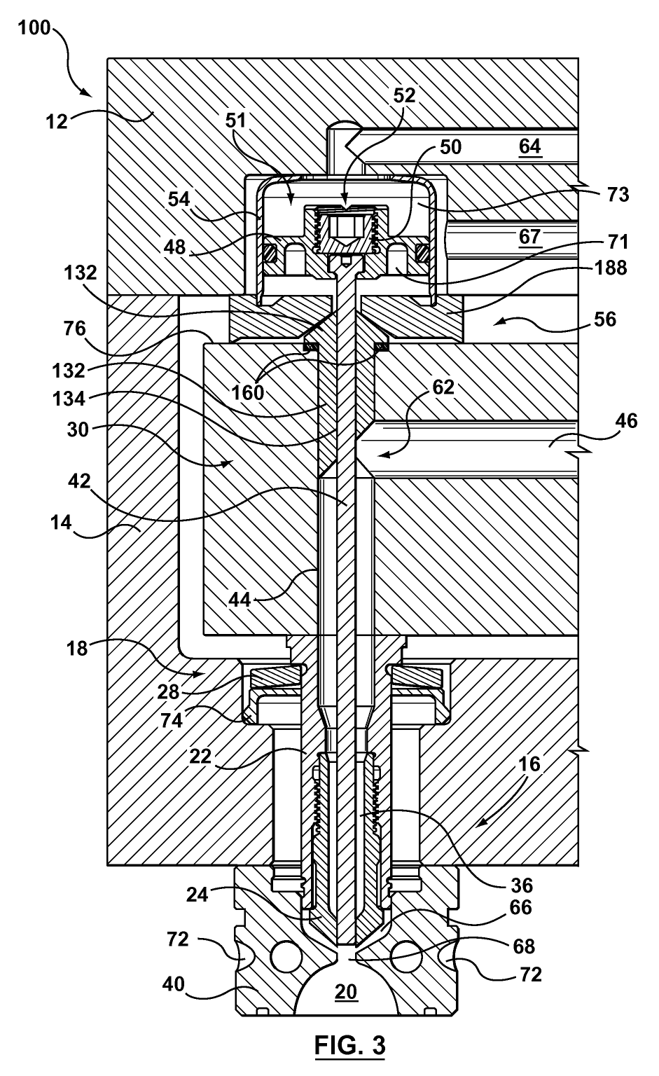

There is a first, alternative embodiment that is shown in FIG. 3 of a hot runner valve gate system for injecting resin into a mold or the like, which is illustrated and generally indicated by numeral 100. The system includes a backing plate 12 and a manifold plate 14. The system also includes a nozzle assembly 18 for introducing melted resin into a mold cavity 20. The nozzle assembly 18 is located within the manifold plate 14 and includes a nozzle housing 22 with a nozzle tip 24 secured thereto. There is a heater (not shown) at least partially positioned on an outside diameter of the nozzle housing 22. The heater may be any suitable heater known in the art to which current is provided by way of an electric cable. There are a wide variety of heat conductive materials that can be utilized for the nozzle housing 22 and an illustrative, but nonlimiting, example includes steel. Also, there is a wide variety of heat conductive materials that can be utilized for the nozzle tip 24 and an illustrative, but nonlimiting, example includes copper alloys.

The nozzle housing 22 includes an axial channel 36 through which melted resin can flow. The nozzle tip 24 surrounds a terminal portion of the axial channel 36. There is a valve stem 42 that controls the opening and closing of the melt channel opening 68 located in the gate insert 40 that controls the flow of melted resin into the mold cavity 20. There is an insulator 66 that occupies the space between the nozzle tip 24 and the gate insert 40 and also contains a melt channel opening 68 located therein. There are cooling channels 72 in the gate insert 40 that allow the melted resin to solidify in the mold cavity 20 prior to the opening of a mold (not shown).

The valve stem 42 can be made of a wide variety of shapes and materials. An illustrative, but nonlimiting, embodiment of a valve stem 42 includes a steel rod. The valve stem 42 extends through a passageway 44 in a manifold 30 and into the nozzle housing 22. The passageway 44 connects to a melt channel 46 located in the manifold 30. The end of the valve stem 42 that is located opposite to the gate insert 40 is connected to piston head 48 by means of a threaded clamp 50.

There is an actuator that is generally indicated by numeral 51, which includes a piston 52 having a piston head 48 that is housed within a cylinder 54 and the backing plate 12. Fluid, e.g., pneumatic air, is selectively provided through a first channel 64 into an upper chamber 73 to apply downward pressure on the piston 52. The downstroke of the piston 52 causes the valve stem 42 to close and/or reduce the cross-sectional area of the gate insert 40 to restrict or stop the flow of melted resin into the mold cavity 20. Fluid, e.g., pneumatic air, is selectively provided through a second channel 67 into a lower chamber 71 to apply upward pressure on the piston 52. The upstroke of the piston 52 causes the valve stem 42 to open and/or increase the cross-sectional area of the gate insert 40 to allow the flow of melted resin into the mold cavity 20.

The manifold 30 is formed between the manifold plate 14 and the backing plate 12 and is separated from the manifold plate 14 and the backing plate 12 by an air gap 56. The manifold 30 includes the melt channel 46 that forms a portion of the hot runner system that transports melted resin from a source (not shown) to the gate insert 40 associated with a mold cavity 20. The manifold 30 houses a valve bushing 32. There is a wide variety of materials that can be utilized for the manifold 30, which can include any suitable metal or heat conducting material known in the art. The valve bushing 132 is preferably, but not necessarily, formed of flexible metal, e.g., strong steel, which has a predictable flexibility when shaped correctly and which can constrict under pressure. The valve bushing 132, which includes an aperture 134, surrounds a portion of the valve stem 42. There is also a melt channel opening 62 that is in fluid relationship with the melt channel 46 in the manifold 30 and the axial channel 36 in the nozzle assembly 18.

There is a disk spring 28 that will deflect as the cylinder 54, the manifold 20, and the nozzle housing 22 expand due to an increase in temperature. This disk spring 28 will create a resilient spring action in the nozzle assembly 18, which is independent of sealing action created by the valve bushing 132 and the manifold 30 as well as between the valve bushing 132 and the backing plate 12. The disk spring 28 is mounted on a nozzle insulator 74, where the nozzle insulator 74 is adjacent to and supports the nozzle housing 22.

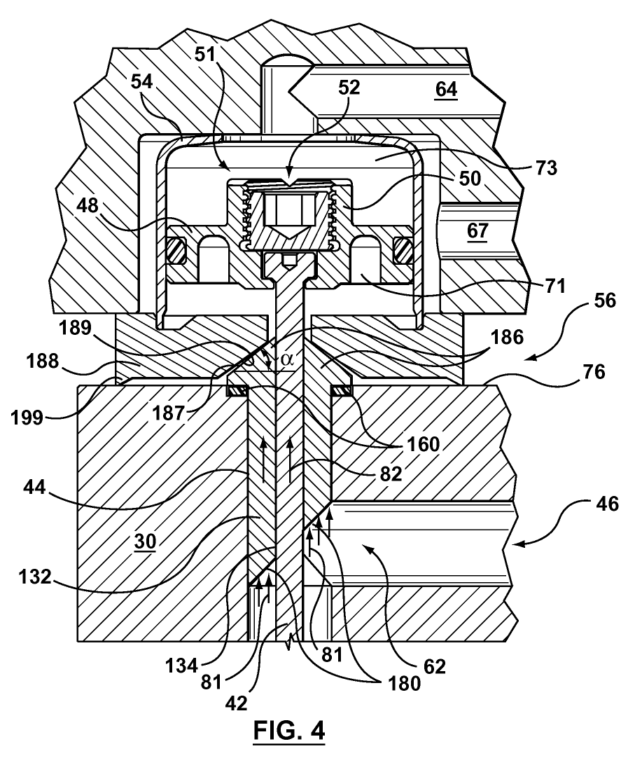

Referring now to FIG. 4 and as previously discussed above, mounted within a manifold 30 is the valve bushing that is indicated by numeral 132. When melted resin enters the melt channel 46 in the manifold 30, the melted resin then passes into a melt channel opening 62 in the passageway 44. The melted resin applies upward pressure 81 against a lower, end portion 180 of the valve bushing 132. This upward injection pressure 81 on the lower, end portion 180 deflects the valve bushing 132 and moves the valve bushing 132 upward axially 82 along the passageway 44.

There is a projecting member 186 extending outward from the valve bushing 132 within the air gap 56. When melted resin enters the melt channel 46 in the manifold 30, the melted resin then passes into a melt channel opening 62 in the passageway 44. The melted resin applies upward pressure 81 against a lower, end portion 180 surrounding an aperture 134 for the valve bushing 132. This injection pressure 81 is applied to the lower end portion 180, which deflects the valve bushing 132 and moves the valve bushing 132 upward axially 82 along the passageway 44.

There is a projecting member 186 extending outward from the valve bushing 132 within the air gap 56. The projecting member 186 preferably includes an angled surface 187. The projecting member 186 is adjacent to and in direct contact with an upper member 188. The upper member 188 preferably includes resilient material, such as, but not limited to, a resilient metal such as steel. Also, the upper member 188 preferably includes an angled surface 189. The angled surfaces 187 and 189 are preferably in an angle α that is in a range from about twenty degrees to about seventy degrees from a line that is perpendicular to the valve stem 42; more preferably, the angle α is in a range from about thirty degrees to about sixty degrees from a line that is perpendicular to the valve stem 42; most preferably, the angle α is in a range from about forty degrees to about fifty degrees from a line that is perpendicular to the valve stem 42, where the optimal value of angle α is forty-five degrees from a line that is perpendicular to the valve stem 42.

There is a seal 160 that is located between the valve bushing 132 and an upper surface 76 for the manifold 30 in the lower portion of the air gap 56. This operates to prevent plastic leakage between the manifold 30 and the valve bushing 132 through passageway 44. Preferably, but not necessarily, there is a leg portion 199 on the upper member 188 that is in direct contact between the upper surface 76 for the manifold 30 in the lower portion of the air gap 56.

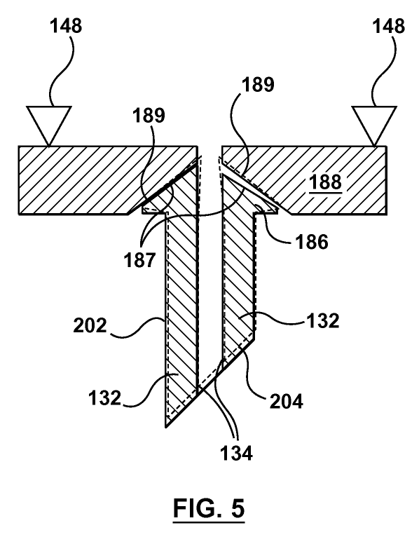

The valve bushing 132 is also shown in FIG. 5 that illustrates an angle mismatch between angled surface 187 of the projecting member 186 and the angled (contacting) surface 189 of the upper member 188. The image on FIG. 5 shows the function of the valve bushing 132 operating as a wedge in an exaggerated state without the presence of a valve stem 42 to support the inner diameter. The solid outline, indicated by numeral 202, depicts the un-deformed state when there is no injection pressure applied, and the dotted outline, indicated by numeral 204, shows how injection pressure causes the valve bushing 132 to move in the axial direction, which causes the passageway 44, as shown on FIG. 4, to constrict due to the conical-type interface at the opposing end. The deflection experienced due to injection pressure should be elastic so that the valve bushing 132 will spring back to its un-deformed state as the pressure is lowered. This operates to prevent contact between the manifold 30 and the valve bushing 132 but does cause the aperture 134 to radially constrict around the valve stem 42, as shown in FIG. 4. There is a graphical representation of the force, indicated by numeral 148, that is exerted by the cylinder 54 for the actuator 51, see FIG. 3.

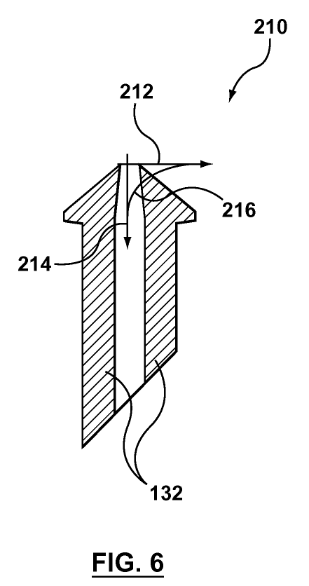

FIG. 6 is a graphical representation that is generally indicated by numeral 210 showing the valve bushing 132. This graphical representation is indicated by numeral 216, which is the contact pressure on the valve stem 212 as a function of the distance from the tip of the bushing 214, which is the condition when applied injection pressure is shown.

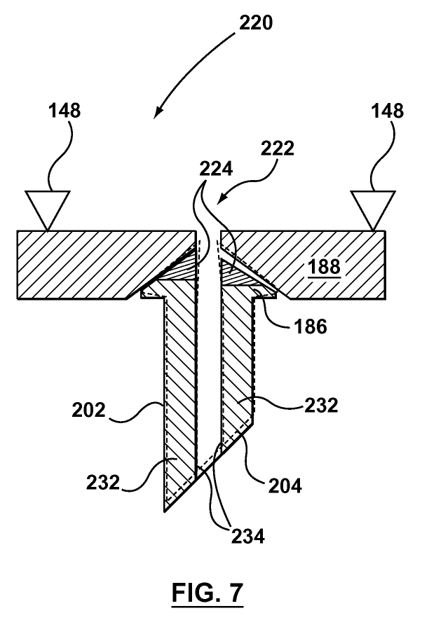

A modification of the alternative embodiment is shown in FIG. 7 and is generally indicated by numeral 220. This modification includes a valve bushing 232 having a top portion 222 that includes a ferrule 224. The ferrule 224 preferably includes resilient material, such as, but not limited to, a resilient metal such as steel. This resilient material is retained by the ferrule 224 to the top portion 222 of the valve bushing 232.

The ferrule 224 responds by constricting an aperture 234 under the pressure exerted by the melted resin alone. The greater the amount of pressure provided by the melted resin, the greater the amount of sealing force provided by the ferrule 224. The solid outline, indicated by numeral 202, depicts the un-deformed state when there is no injection pressure applied, and the dotted outline, indicated by numeral 204, shows how injection pressure causes the valve bushing 232 to move in the axial direction, which causes the passageway 44, as shown on FIG. 4, to constrict due to the conical-type interface at the opposing end. The deflection experienced due to injection pressure should be elastic so that the ferrule 224 for the valve bushing 232 will spring back to its un-deformed state as the pressure is lowered. This operates to prevent plastic leakage between the manifold 30 and the valve bushing 232.

The various valve bushing examples shown above illustrate a novel valve bushing and associated method of use. A user of the present invention may choose any of the above valve bushing embodiments, or an equivalent thereof, depending upon the desired application. In this regard, it is recognized that various forms of the subject invention could be utilized without departing from the spirit and scope of the present invention.

Other aspects, objects and advantages of the present invention can be obtained from a study of the drawings, the disclosure and the appended claims. Thus, there has been shown and described several embodiments of a novel invention. As is evident from the foregoing description, certain aspects of the present invention are not limited by the particular details of the examples illustrated herein, and it is therefore contemplated that other modifications and applications, or equivalents thereof, will occur to those skilled in the art. The terms “have,” “having,” “includes” and “including” and similar terms as used in the foregoing specification are used in the sense of “optional” or “may include” and not as “required.” Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention, which is limited only by the claims that follow.

1. An injection molding apparatus comprising:
an actuator;
a manifold having an internal channel for the flow of melted resin;
a valve stem, having a longitudinal axis, and is operatively connected to the actuator and movable within at least a portion of the internal channel of the manifold; and
a valve bushing that at least partially encircles the valve stem along the longitudinal axis, wherein the valve bushing includes a projecting member so that when pressure is applied to a bottom portion of the valve bushing, that deflection of the valve bushing occurs along the longitudinal axis of the valve stem, which is then translated into radial constriction by the projecting member of the valve bushing to reduce leakage.

2. The injection molding apparatus according to claim 1, wherein the projecting member is a cantilevered structure.

3. The injection molding apparatus according to claim 1, wherein the projecting member is substantially m-shaped.

4. The injection molding apparatus according to claim 1, wherein the projecting member is a cantilevered structure that is substantially m-shaped.

5. The injection molding apparatus according to claim 1, wherein the projecting member is at an angle upward towards the actuator from a line perpendicular to the longitudinal axis of the valve stem in a range from about twenty degrees (20°) to about sixty degrees (60°).

6. The injection molding apparatus according to claim 1, wherein the projecting member is at an angle upward towards the actuator from a line perpendicular to the longitudinal axis of the valve stem in a range from about forty degrees (40°) to about fifty degrees (50°).

7. The injection molding apparatus according to claim 1, wherein the first valve bushing includes at least one leg portion that is transverse to the projecting member.

8. The injection molding apparatus according to claim 7, wherein the at least one leg portion is substantially perpendicular to the projecting member.

9. The injection molding apparatus according to claim 1, wherein the valve bushing is formed of resilient material that can constrict under pressure.

10. The injection molding apparatus according to claim 9, wherein the resilient material includes metal alloys.

11. The injection molding apparatus according to claim 1, further includes at least one spacer located adjacent to the valve bushing.

12. The injection molding apparatus according to claim 1, further includes an upper member that is positioned adjacent to the projecting member so that when pressure is applied to the bottom portion of the valve bushing, that deflection of the valve bushing occurs along the longitudinal axis of the valve stem, which is then translated into radial constriction by the projecting member of the valve bushing being wedged against a contacting surface of the upper member to reduce leakage.

13. The injection molding apparatus according to claim 12, wherein the projecting member is conical.

14. The injection molding apparatus according to claim 12, wherein the upper member is cylindrical.

15. The injection molding apparatus according to claim 12, wherein the upper member includes a center portion and an outer portion having at least one leg member that is transverse to the main portion.

16. The injection molding apparatus according to claim 12, wherein an angle of contact between the valve bushing and the upper member is from a line perpendicular to the longitudinal axis of the valve stem extending towards to the manifold in a range from about twenty degrees (20°) to about sixty (60°) degrees.

17. The injection molding apparatus according to claim 12, wherein an angle of contact between the valve bushing and the upper member is from a line perpendicular to the longitudinal axis of the valve stem extending towards to the manifold in a range from about forty degrees (40°) to about fifty (50°) degrees.

18. The injection molding apparatus according to claim 12, wherein the upper member is formed of resilient material that can constrict under pressure.

19. The injection molding apparatus according to claim 12, wherein the projecting member includes a top portion having a ferrule, which includes resilient metal, wherein the ferrule can provide constriction to reduce leakage.

20. An injection molding apparatus comprising:
an actuator;
a manifold having an internal channel for the flow of melted resin;
a valve stem, having a longitudinal axis, and is operatively connected to the actuator and movable within at least a portion of the internal channel of the manifold; and
a valve bushing that at least partially encircles the valve stem along the longitudinal axis, wherein the valve bushing includes a projecting member; and
an upper member that is positioned adjacent to the projecting member so that when pressure is applied to a bottom portion of the valve bushing, that deflection of the valve bushing occurs along the longitudinal axis of the valve stem, which is then translated into radial constriction, by the projecting member of the valve bushing being wedged against a contacting surface of the upper member, to reduce leakage.

21. An injection molding apparatus comprising:
an actuator;
a manifold having an internal channel for the flow of melted resin;
a valve stem, having a longitudinal axis, and is operatively connected to the actuator and movable within at least a portion of the internal channel of the manifold;
a valve bushing that at least partially encircles the valve stem along the longitudinal axis, and includes a projecting member, wherein the projecting member includes a top portion having a ferrule, which includes resilient metal; and
an upper member that is positioned adjacent to the projecting member so that melted resin, without requiring force against a bottom portion of the valve stem, can apply pressure to the ferrule, which is then translated into radial constriction, by the projecting member of the valve bushing being wedged against a contacting surface of the upper member, to reduce leakage.

22. An injection molding apparatus comprising:
an actuator located within a backing plate having a surface;
a manifold having an internal channel for the flow of melted resin and having a surface;
a valve stem, having a longitudinal axis, and is operatively connected to the actuator and movable within the internal channel of the manifold; and
a valve bushing, having a bottom portion and located between the manifold and the backing plate, that at least partially encircles the valve stem along the longitudinal axis, wherein the valve bushing includes a projecting member that is in contact with the surface of the backing plate so that when pressure is applied to a bottom portion of the valve bushing, that deflection of the valve bushing occurs along the longitudinal axis of the valve stem, which is then translated into radial constriction by the projecting member of the valve bushing to reduce leakage.

23. A valve bushing for use in an injection molding apparatus, which includes an actuator, a manifold having an internal channel for the flow of melted resin, and a valve stem, having a longitudinal axis, and is operatively connected to the actuator and movable within at least a portion of the internal channel of the manifold, the valve bushing comprising:
a projecting member so that when pressure is applied to a bottom portion of the valve bushing, that deflection of the valve bushing occurs along the longitudinal axis of the valve stem, which is then translated into radial constriction by the projecting member of the valve bushing to reduce leakage, wherein the valve bushing that at least partially encircles the valve stem along the longitudinal axis.

24. The valve bushing for use in an injection molding apparatus according to claim 23, wherein the projecting member is a cantilevered structure.

25. The valve bushing for use in an injection molding apparatus according to claim 23, wherein the projecting member is at an angle upward towards the actuator from a line perpendicular to the longitudinal axis of the valve stem in a range from about twenty degrees (20°) to about sixty degrees (60°).

26. The valve bushing for use in an injection molding apparatus according to claim 23, wherein the first valve bushing includes at least one leg portion that is transverse to the projecting member.

27. The valve bushing for use in an injection molding apparatus according to claim 23, wherein the valve bushing is formed of resilient material that can constrict under pressure.

28. The valve bushing for use in an injection molding apparatus according to claim 23, further includes an upper member that is positioned adjacent to the projecting member so that when pressure is applied to the bottom portion of the valve bushing, deflection of the valve bushing occurs along the longitudinal axis of the valve stem, which is then translated into radial constriction by the projecting member of the valve bushing being wedged against a contacting surface of the upper member to reduce leakage.

29. The valve bushing for use in an injection molding apparatus according to claim 23, wherein an angle of contact between the valve bushing and the upper member is from a line perpendicular to the longitudinal axis of the valve stem extending towards to the manifold in a range from about twenty degrees (20°) to about sixty (60°) degrees.

30. The valve bushing for use in an injection molding apparatus according to claim 23, wherein the upper member is formed of resilient material that can constrict under pressure.

31. The valve bushing for use in an injection molding apparatus according to claim 23, wherein the projecting member includes a top portion having a ferrule, which includes resilient metal, wherein the ferrule can provide constriction to reduce leakage.

32. A method of utilizing an injection molding apparatus comprising:
utilizing a valve bushing that at least partially encircles the valve stem along a longitudinal axis, wherein the valve bushing includes a projecting member so that when pressure is applied to a bottom portion of the valve bushing, that deflection of the valve bushing occurs along the longitudinal axis of the valve stem, which is then translated into radial constriction by the projecting member of the valve bushing to reduce leakage, wherein the valve stem is operatively connected to an actuator and movable within at least a portion of an internal channel of a manifold.

33. The method of utilizing an injection molding apparatus according to claim 32, wherein the projecting member is a cantilevered structure that is substantially m-shaped.

34. The method of utilizing an injection molding apparatus according to claim 32, wherein the projecting member is at an angle upward towards the actuator from a line perpendicular to the longitudinal axis of the valve stem in a range from about twenty degrees (20°) to about sixty degrees (60°).

35. The method of utilizing an injection molding apparatus according to claim 32, wherein the first valve bushing includes at least one leg portion that is transverse to the projecting member.

36. The method of utilizing an injection molding apparatus according to claim 32, wherein the valve bushing is formed of resilient material that can constrict under pressure.

37. The method of utilizing an injection molding apparatus according to claim 32, further includes utilizing an upper member that is positioned adjacent to the projecting member so that when pressure is applied to the bottom portion of the valve bushing, that deflection of the valve bushing occurs along the longitudinal axis of the valve stem, which is then translated into radial constriction by the projecting member of the valve bushing being wedged against a contacting surface of the upper member to reduce leakage.

38. The method of utilizing an injection molding apparatus according to claim 32, wherein the projecting member is conical and the upper member is cylindrical.

39. A method of utilizing an injection molding apparatus comprising:
utilizing a valve bushing that at least partially encircles the valve stem along a longitudinal axis, wherein the valve bushing includes a projecting member, wherein the projecting member includes a top portion having a ferrule, which includes resilient metal so that melted resin can apply pressure to the ferrule which is then translated into radial constriction by the projecting member of the valve bushing to reduce leakage without requiring pressure being applied to a bottom portion of the valve bushing.
